(19) United States
(12) Patent Application Publication
(10) Pub. No.: US 2013/0051176 A1
(43) Pub. Date: Feb. 28, 2013

(54) SEISMIC ACQUISITION USING SOLID STREAMERS

(71) Applicants: Gary John Tustin, Sawston (GB); Steven Antony Gahlings, Great Cambourne (GB); Robert Hughes Jones, Fen Drayton (GB)

(72) Inventors: Gary John Tustin, Sawston (GB); Steven Antony Gahlings, Great Cambourne (GB); Robert Hughes Jones, Fen Drayton (GB)

(73) Assignee: WESTERNGECO L.L.C., HOUSTON, TX (US)

(21) Appl. No.: 13/519,838

(22) PCT Filed: Dec. 24, 2010
(86) PCT No.: PCT/IB10/03352

§ 371 Date: Oct. 23, 2012

Related U.S. Application Data
(60) Provisional application No. 61/291,420, filed on Dec. 31, 2009.

(51) Int. Cl. G01V 1/38; G01V 1/16; G01V 1/24

(52) U.S. Cl. 367/20; 367/153

(57) ABSTRACT

Some embodiments of the disclosed invention include a method for acquiring marine seismic data using solid streamers in a curved pattern. Streamers can be towed in a curved pattern within a body of water. While being towed in the curved patter the source may be fired and response data can be collected by the streamers as they are towed through the water in the curved/circular pattern. These streamers can be solid streamers and can be filled with a gel like substance. Moreover, the streamers can be placed at various known depths within the body of water.

### BACKGROUND

This disclosure generally relates to acquiring marine seismic data, and more specifically but not by way of limitation to acquiring marine seismic data using solid streamers.

Seismic exploration involves surveying subterranean geological formations for hydrocarbon deposits. A seismic survey typically involves deploying seismic source(s) and seismic sensors at predetermined locations. The sources generate seismic waves, which propagate into the geological formations creating pressure changes and vibrations along their way. Changes in elastic properties of the geological formation scatter the seismic waves, changing their direction of propagation and other properties. Part of the energy emitted by the sources reaches the seismic sensors. Some seismic sensors are sensitive to pressure changes (e.g., hydrophones), others to particle motion (e.g., geophones), and industrial/seismic surveys may deploy only one type of sensors or both. In response to the detected seismic events, the sensors generate electrical signals to produce seismic data. Analysis of the seismic data can then indicate the presence or absence of probable locations of hydrocarbon deposits.

Some surveys are known as “marine” surveys because they are conducted in marine environments. However, “marine” surveys may be conducted not only in saltwater environments, but also in fresh and brackish waters. In one type of marine survey, called a “towed-array” survey, an array of seismic sensor-containing streamers and sources is towed behind a survey vessel.

Streamers are long cables that house various sensor networks and other devices useful in the acquisition of seismic data. Streamers may be manufactured as liquid-filled streamers or solid streamers. Prior art solid streamer cables are often constructed with a central core with transmission and power bundles that are continuous through the streamer section (a segmented portion of a streamer cable). The transmission and power bundles are typically connected to electronics modules between the streamer sections through end connectors. Also within a streamer section, there is a need to connect distributed sensors and (if present) sensor electronics by wires to transmit power and data to the electronics modules.

### BRIEF SUMMARY

Some embodiments of the disclosed invention include a method for acquiring marine seismic data using solid streamers in a curved pattern. Streamers and a source may be towed in a curved pattern within a body of water. While being towed in the curved pattern, a seismic source, such as an air gun or the like, may be fired and response data may be collected by the streamers as they are towed through the water in a curved, circular and/or coiled type pattern. For purposes of this application the term coil shooting may refer to the towing of streamers through a body of water in a curved, circular and/or coiled pattern. These streamers may comprise solid streamers, where the solid streamers may be filled with a gel like substance. Moreover, the streamers may be positioned at various depths within the body of water.

Embodiments of the invention provide a method for acquiring marine using one or more solid streamers in a coil shooting process. In one embodiment, a system for acquiring marine seismic data is provided, the system comprising one or more solid streamers and one or more advancing curved sail lines. In certain aspects, the solid streamer may comprise a gel, a thermoplastic elastomer, a permanent gel, a thermo-reversible gel, a polymer, a cross-linked polymer or the like. In some aspects of the invention, the solid streamer comprises Kraton G.

Embodiments of the invention provide a method processing marine seismic data, comprising using a processor to process marine seismic data obtained from one or more solid streamers in a coil shooting process. In other embodiments a method for acquiring marine seismic data is described the method comprising towing one or more solid streamers at a first depth and towing one or more solid streamers at a second depth, wherein the second depth is deeper than the first depth. In certain aspects of the invention, the solid streamers are towed at the first depth at a first temporal location and the solid streamers are towed at the second depth at a different temporal location. In further aspects of the invention, a first sensor is provided at the first depth to sense first conditions at the first depth; and a second sensor is provided at the second depth to sense second conditions at the second depth. The different conditions may be used to process a seismic picture, wavefield and/or the like from the outputs from the solid streamers towed at the first depth and the solid streamers towed at the second depth.

In one embodiment of the present invention, a method for acquiring marine seismic data is provided, the method comprising: placing a seismic source in a body of water; placing a first streamer in the body of water, wherein the first streamer comprises a solid filler material and one or more sensors; towing at least one of the first streamer and the source in a curved pattern through the body of water; firing the source in the body of water; and collecting data from the first streamer as the first streamer is towed through the body of water in the curved pattern.

In aspects of the present invention, the curved motion of the first streamer through the body of water causes a shear stress to be applied to the solid filler material. In an embodiment of the present invention, the application of the shear stress to the solid filler material may be used to process accurate/high signal-to-noise seismic data from the signals detected by the sensors in the first streamer.

In a further embodiment of the present invention, a seismic streamer is provided, the seismic streamer comprising: a streamer body having a length and a channel, a solid streamer core disposed within the channel of the streamer body; a seismic sensor disposed within the channel of the streamer body; a wire coupled with the seismic sensor and disposed within the streamer body channel having a length, wherein the wire length is longer than the length of the streamer housing; and means for imparting slack in the wire within the streamer body channel.

In another embodiment of the present invention, a method for acquiring marine seismic data is provided, the method comprising: placing a first streamer in a body of water at a first depth, wherein the first streamer comprises a solid streamer; placing a second streamer in the body of water at a second depth that is deeper than the first depth, wherein the second streamer comprises a solid streamer; placing a source in the body of water; towing the first streamer, the second streamer, and the source through the body of water in a curved pattern; firing the source while the source is being towed through the body of water in the curved pattern; and collecting first data from the first streamer and second data from the second streamer as they are towed through the body of water.

### BRIEF DESCRIPTION OF THE DRAWINGS

In the figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a cross-sectional view of a solid streamer cable.

FIG. 2 is a diagram of a marine seismic data acquisition system according to some embodiments of the invention.

FIG. 3 is a cut-away view of a streamer cable according to one embodiment of the invention.

FIG. 4 is a cross-sectional view of the streamer cable taken along the line 4-4 in FIG. 3.

FIG. 5 is a cross-sectional view of the streamer cable taken along the line 5-5 in FIG. 4.

FIG. 6 is a modification of FIG. 5 to illustrate another embodiment of the invention.

FIG. 7 is a stress diagram illustrating exemplary stress forces undergone by a streamer cable.

FIG. 8 is a plan, overhead schematic view of a coil shoot according to some embodiments of the invention.

FIG. 9 is a computerized rendition of a plan view of the survey area covered by generally circular sail lines progressing over time according to some embodiments of the invention.

FIG. 10 is a plan, overhead view of a survey spread according to some embodiments of the invention.

FIG. 11 is a plan, overhead view of a two-depth survey spread according to some embodiments of the invention.

FIG. 12 is a diagram of a two-depth marine seismic data acquisition system according to some embodiments of the invention.

FIG. 13 is a flow chart of a process for using solid streamers in a curved pattern according to some embodiments of the invention.

FIG. 14 is a flow chart of a process for using solid streamers in two depths in a curved pattern according to some embodiments of the invention.

### DETAILED DESCRIPTION OF THE INVENTION

The ensuing description provides some embodiment(s) of the invention, and is not intended to limit the scope, applicability or configuration of the invention or inventions. Various changes may be made in the function and arrangement of elements without departing from the scope of the invention as set forth herein. Some embodiments maybe practiced without all the specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Some embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure and may start or end at any step or block. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

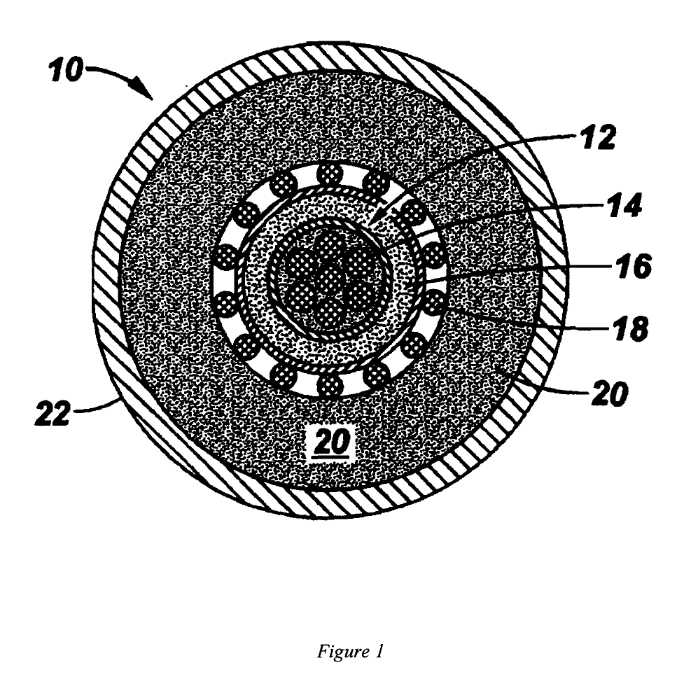

FIG. 1 is a cross section of a solid streamer cable 10 includes a central core 12 having transmission bundle 14 surrounded by a strength member 16. Central core 12 is typically pre-fabricated before adding sensors and/or sensor electronics. Local wiring 18, which is used to connect the sensor and sensor electronics, is also disposed in streamer cable 10 inside of a polymer body 20 and a skin 22. The typical way to dispose wiring 18 within streamer cable 10 is to twist the wiring onto the central core 12 with a certain lay-length (or pitch) to allow for tensile cycling and bending of streamer cable 10 without generating high stresses in the wires. Wiring layers in prior art solid cables are often pre-made with the central core 12.

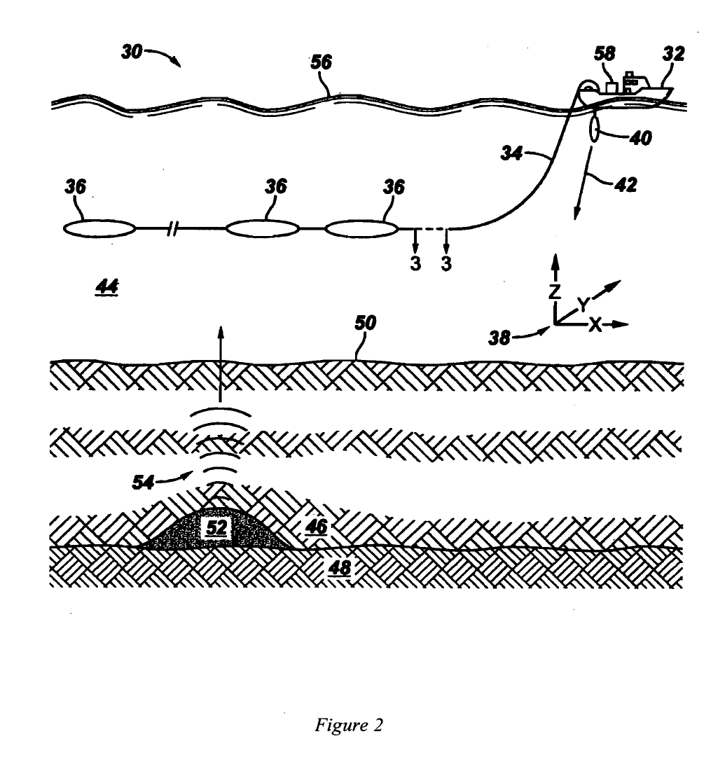

FIG. 2 depicts a marine seismic data acquisition system 30 in accordance with some embodiments of the disclosure. In system 30, a survey vessel 32 tows one or more seismic streamer(s) 34 (e.g., streamer 10 depicted in FIG. 1) behind vessel 20. Seismic streamer(s) 34 may be several thousand meters long and may contain various support cables, as well as wiring and/or circuitry that may be used to support communication along the streamer(s) 34. In general, each streamer 30 can include a primary cable into which is mounted seismic sensors 36 that record seismic signals. An example of sensors 36 is illustrated schematically in FIG. 2, and that in practice, the sensors 36 are disposed within the streamer cable 34.

In accordance with embodiments of the disclosure, seismic sensors 36 may be pressure sensors only or may be multi-component seismic sensors. For the case of multi-component seismic sensors, each sensor is capable of detecting a pressure wavefield and at least one component of a particle motion that is associated with acoustic signals that are proximate to the multi-component seismic sensor. Examples of particle motions include one or more components of a particle displacement, one or more components (inline (x), crossline (y) and vertical (z) components) of a particle velocity and one or more components of a particle acceleration.

Depending on the particular embodiment of the disclosure, the multi-component seismic sensor may include one or more hydrophones, geophones, particle displacement sensors, particle velocity sensors, accelerometers, pressure gradient sensors, or combinations thereof.

For example, in accordance with some embodiments of the invention, a particular multi-component seismic sensor may include a hydrophone for measuring pressure and three orthogonally-aligned accelerometers to measure three corresponding orthogonal components of particle velocity and/or acceleration near the seismic sensor. The multi-component seismic sensor may be implemented as a single device or may be implemented as a plurality of devices, depending on the particular embodiment of the disclosure. A particular multi-component seismic sensor may also include pressure gradient sensors, which constitute another type of particle motion sensors. Each pressure gradient sensor measures the change in the pressure wavefield at a particular point with respect to a particular direction. For example, one of the pressure gradient sensors may acquire seismic data indicative of, at a particular point, the partial derivative of the pressure wavefield with respect to the crossline direction, and another one of the pressure gradient sensors may acquire, a particular point, seismic data indicative of the pressure data with respect to the inline direction.

The marine seismic data acquisition system can include seismic source 40 that may be formed from one or more seismic source elements, such as air guns, for example, which are connected to survey vessel 32. Alternatively, in other embodiments of the disclosure, seismic source 40 may operate independently of survey vessel 32, in that seismic source 40 may be coupled to other vessels or buoys, as just a few examples.

As seismic streamer(s) 34 are towed behind survey vessel 32, acoustic signals 42, often referred to as “shots”, are produced by seismic source 40 and are directed down through a water column 44 into strata 46 and 48 beneath water bottom surface 50. The acoustic signals 42 are reflected from the various subterranean geological formations, such as formation 52.

The incident acoustic signals 42 that are provided by seismic source 40 produce corresponding reflected acoustic signals, or pressure waves 54, which are sensed by seismic sensors 36. The pressure waves that are received and sensed by seismic sensors 36 include “up going” pressure waves that propagate to seismic sensors 36 without reflection, as well as “down going” pressure waves that are produced by reflections of pressure waves 54 from air-water boundary 56.

Seismic sensors 36 generate signals (digital signals, for example), called “traces,” that indicate the acquired measurements of the pressure wavefield and particle motion (if the sensors are particle motion sensors). The traces can be recorded and may be at least partially processed by signal processing unit 58 that is deployed on survey vessel 32, in accordance with some embodiments of the disclosure. For example, a particular multi-component seismic sensor may provide a trace, which corresponds to a measure of a pressure wavefield by its hydrophone; and the sensor may provide one or more traces that correspond to one or more components of particle motion, which are measured by its accelerometers.

The goal of the seismic acquisition is to build up an image of a survey area for purposes of identifying subterranean geological formations, such as geological formation 52. Subsequent analysis of the representation may reveal probable locations of hydrocarbon deposits in subterranean geological formations. Depending on the particular embodiment of the disclosure, portions of the analysis of the representation may be performed on the seismic survey vessel 32, such as by the signal processing unit 58.

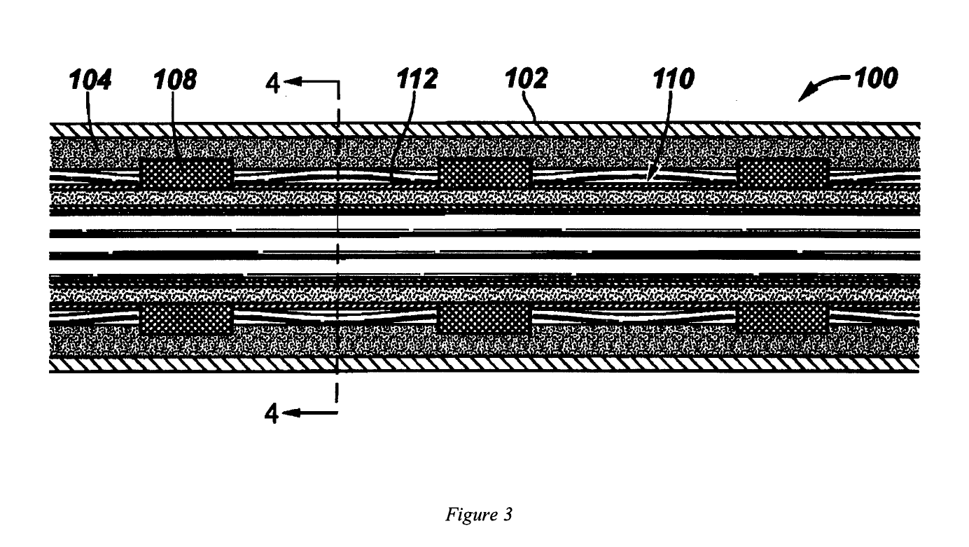

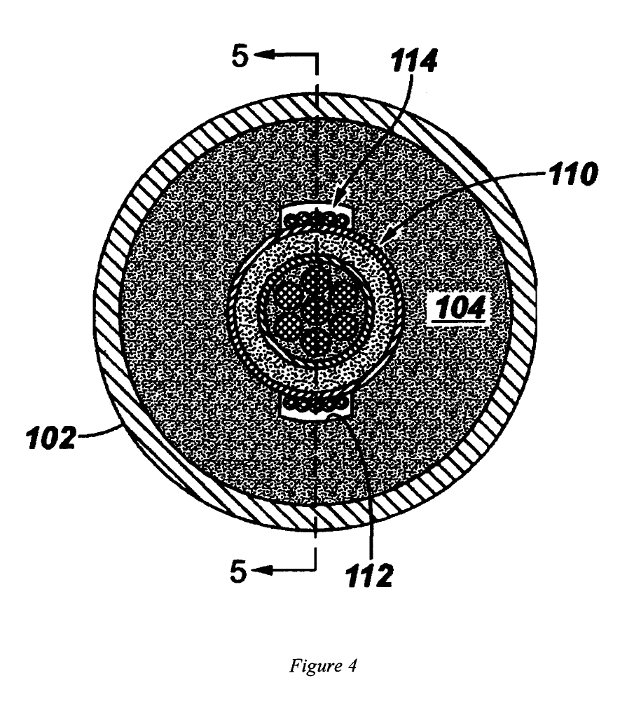

Referring to FIG. 3, solid streamer cable 100 according to one embodiment of the present disclosure can include skin 102 encloses polymer body 104 and one or more seismic devices 108 for use in seismic data acquisition. Seismic devices 108 may include seismic sensors (e.g., geophone, hydrophone and/or accelerometer) and/or sensor electronics that generally manipulate data acquired by the seismic sensors, such as an analog to digital converter that digitizes the analog data acquired by the sensors. In practice, the seismic devices 108 may be disposed within a housing. Core 110 is also disposed within streamer cable 100 and may comprise a strength member and often also a transmission bundle (not shown). In some embodiments, core 110 is substantially solid. Channel 112 is formed in polymer body 104 in an area generally adjacent to core 110. In some embodiments, channel 112 can be formed in polymer body 104 away from core 110. Referring to FIG. 4, channel 112 provides a pathway for a wire bundle 114 to connect the various seismic devices 108 disposed within streamer cable 100. In this embodiment, wire bundle 114 extends through the channel inline with the central core, thus providing easy access to the wire bundle for technicians to connect and/or disconnect the wires to the associated seismic devices 108.

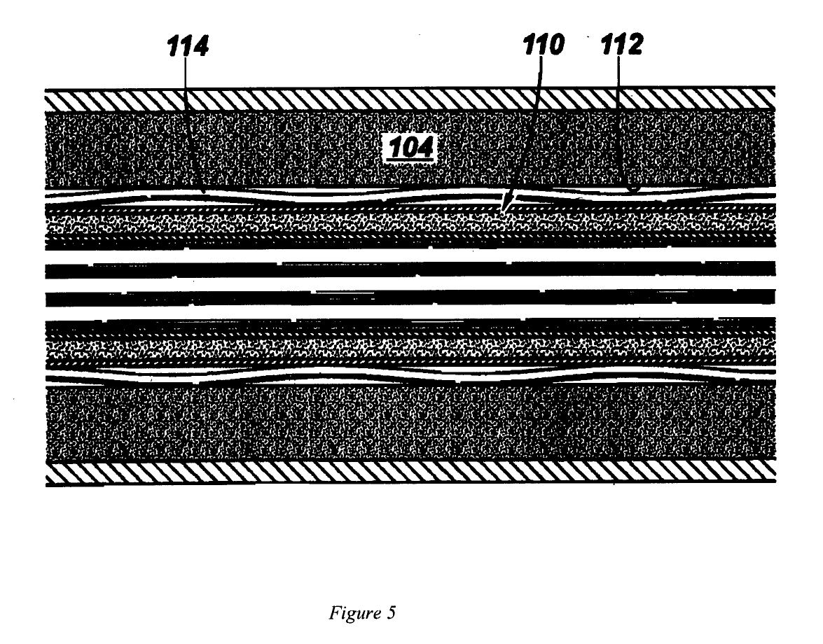

Referring to FIG. 5, wires 114 can be formed such that they can have slack when extending through streamer cable 100. Slack may be imparted to wires 114 by ensuring that the wires are longer when straight than streamer cable 100. The additional length of wires 114 relative to the streamer cable may be referred to as “over-length.” To accommodate the over-length, wires 114 may be formed to have a corrugated or S-shape when extending through the cable. In corrugated embodiments, wires 114 may be run through teethed wheels or pre-formed plates to thus impart corrugation to the wires prior to insertion within streamer cable 100. By having slack, wires 114 can withstand the various compressional or tensional loads experienced by streamer cable 100 during deployment and operation.

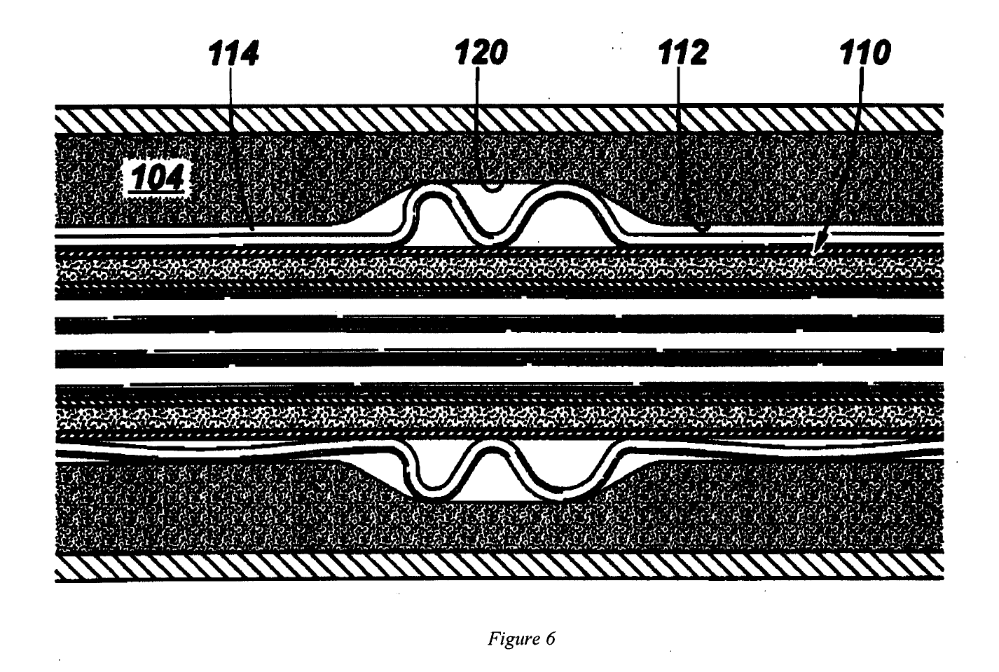

Additional process can be used to impart slack to wires 114. For example, with reference to FIG. 6, slack may be imparted to wires 114 only at certain points along channel 112. To accommodate such slack, enlarged cavities, such as cavity 120, may be defined in polymer body 104 along certain portions of channel 112. Accordingly, in this embodiment, wires 114 can be substantially taut along some segments of channel 112 yet incorporate slack at enlarged cavities 120.

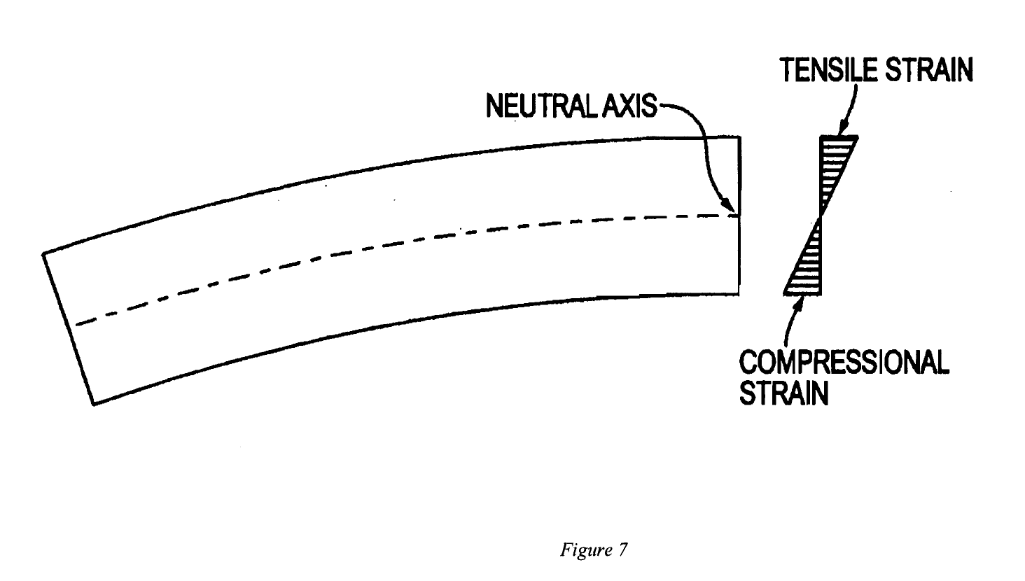

By imparting slack to wires 114, elongation or bending of the streamer cable will only impose a portion of the tensional forces experienced by streamer cable 100 onto the wires compared to the greater amount of tensional forces that would be experienced by taut wires. In practice, streamer cables are typically rolled on a spool and placed on a vessel for deployment at sea. Rolling a streamer cable on a spool can introduce undesirable bending strains, particularly with respect to solid streamer cables. Referring to FIG. 7, the maximum bending strain over the cross section for cable 100 will be influenced by the cable and spool diameter. In one example, if the cable diameter is 50 mm and the spool diameter is 1400 mm, the maximum bending strain can be calculated as 3.44% at the outermost portion of the cable (25 mm out of center). Such strain will be realized as compression and tensile strain over the cross section of the cable 100. Compression and tensile strain experienced by wires 114 can lead to undesirable wire breaks.

The manufacturing process associated with assembling streamer cable 100 according to the present disclosure can thus be simplified. In particular, by placing wires 114 through the inline channel 112, sensors 106 and wires can be connected, tested and pre-made before the step of assembling the sensors and core 110 together. In one embodiment, this can be realized if polymer body 104 was manufactured in two halves (or other multiple) that are then secured together during manufacturing. In another embodiment, the sensor network (sensor 106, wires 114 and electronics 108) may be pre-assembled inside a portion of polymer body 104 and then later assembled together with core 110.

FIGS. 2-7 and the associated description describe solid streamers that may be used in accordance with the present invention. In embodiments of the invention, solid streamers comprising a seismic streamer at least partially filled with a gel, thermoplastic elastomer, polymer or the like may be used. For example, solid streamers comprising thermally reversible gels, such as Kraton G or the like may be used in embodiments of the invention. In such embodiments, the thermally reversible gel may be used to fill the empty spaces with the streamer. The gel can be removed for maintenance purposes. The solid streamers may comprise existing streamer designs with a gel, thermoplastic elastomer, polymer or the like being used to fill the streamer instead of kerosene or a liquid. In some embodiments, the solid streamer may comprise a material that maintains a solid form when released into a body of water such that the material may be retried, may block leakage from the streamer and/or may limit any harmful environmental effects. In some applications, the material may be a non-environmentally harmful material. In some embodiments, the material can include a thermo-gel in combination with a isoparaffin. In some embodiments, the thermo-gel can include an oil gel and/or a polymer gel. For example, the thermo-gel can be a Kraton® thermo-gel. In some embodiments, the isoparaffin can include Isopar fluid. Various combinations of a thermo-gel and an isoparaffin can be used. For example, the material can include 5, 10, 15, 20, 25, 30, 35, or 40 wt % of Kraton thermo-gel can be used in conjunction with 95, 90, 85, 80, 75, 70, 65, 60 wt % isoparaffin.

Wire bundle 114, for example, can contain one or more wires. Thus this disclosure is not limited to only those embodiments having a plurality of wires in the wire bundle. Also, channel 112 and cavity 120 may be filled with air or a compliant material. This disclosure cover all such modifications and variations as fall within the scope of this present disclosure

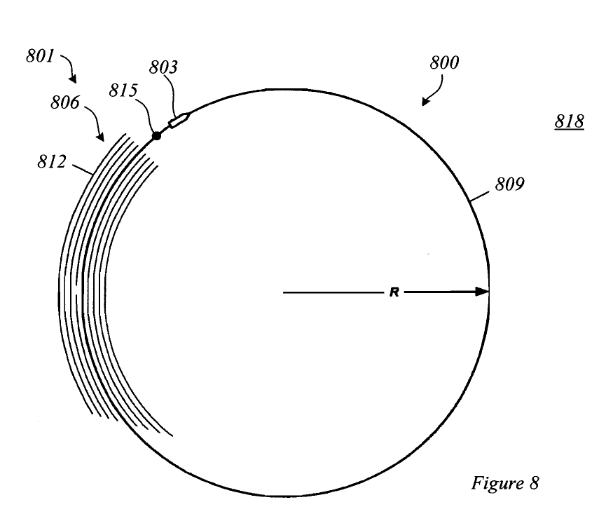

Turning now to coil shooting, FIGS. 8-10 generally illustrate a coil shoot, towed-array marine seismic survey and one particular apparatus by which it may be performed.

FIG. 8 depicts a portion of a towed-array in a marine seismic survey 800 according to some embodiments of the invention. Seismic survey 800 can include seismic spread 801, which comprises survey vessel 803 towing an array 806 on a generally advancing curved path over sail line 809. In the illustrated embodiment, the array 806 includes a plurality of streamers 812 and source 815. Sail line 809 does not have a tangible manifestation, and that sail line 809 in the drawing graphically represents that which is intangible in practice. Seismic survey 800 is being conducted in a survey area 818.

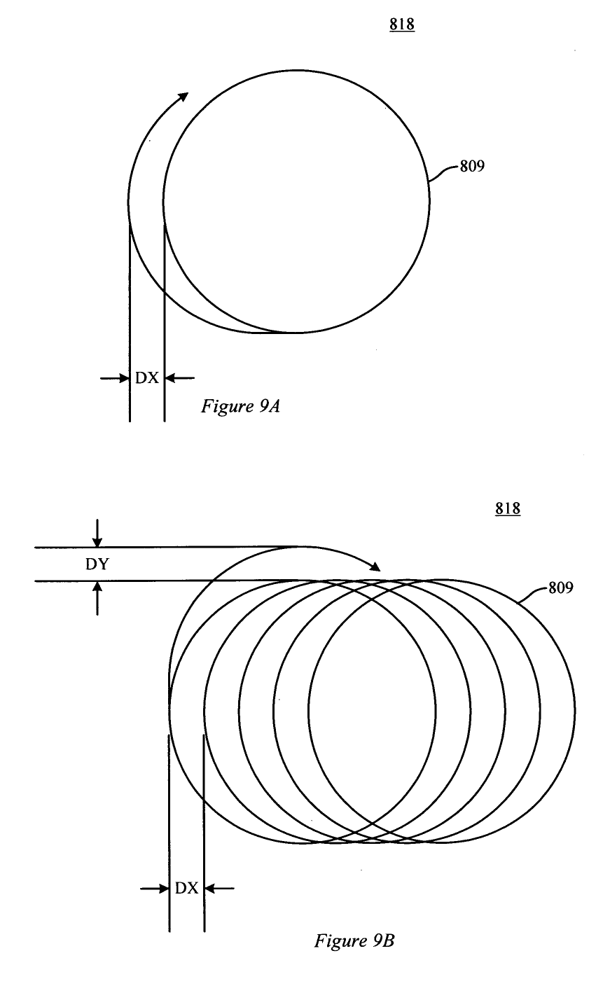

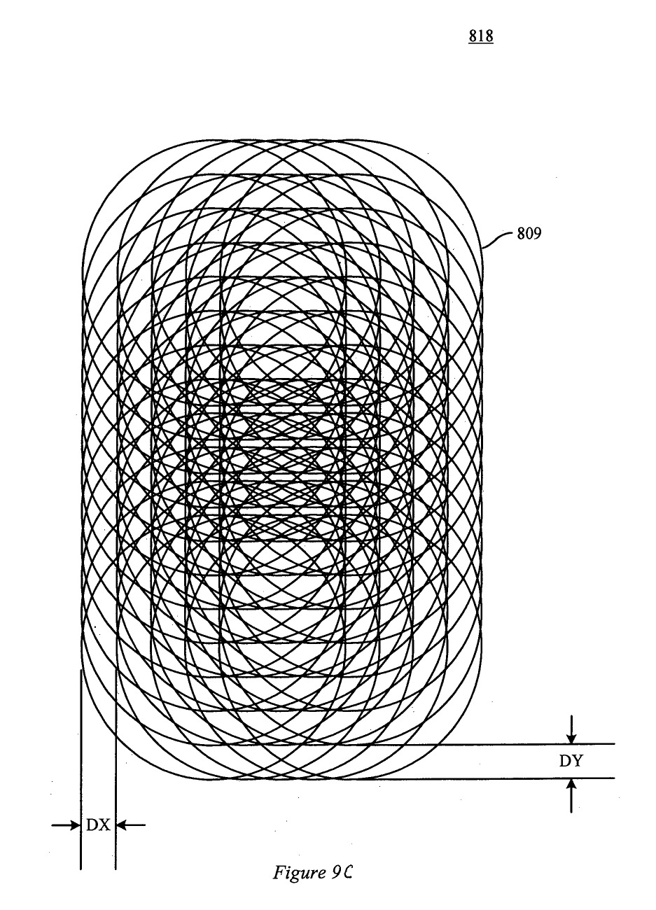

Sail line 809 may not be truly circular. Once the first pass is substantially complete, survey 800 can move spread 801 slightly in either or both the x-direction (horizontal) a distance of DX or the y-direction (vertical) a distance of DY, as illustrated in FIGS. 9A-9C. While the x-axis and the y-axis are defined relative to the plane of the drawing, in practice they can be arbitrary.

FIGS. 9A-9C are plan views of progressing circular sail lines 809 of seismic spread 801 shown in FIG. 8. Sail lines 809 are generally followed by a boat pulling seismic streamers. The streamers can progress along either of both the x-axis and the y-axis over time during a coil shooting and recording survey. While sail lines 809 are generally circular, various other curved paths may be taken such as ovals, and the like. Sail lines 809 are generally circular, but within the nautical limits to command a ship in such a manner and on the influences of current and the environment on the boat following sail lines 809. The displacement from circle to circle is DY in the vertical direction and DX in the horizontal direction. In FIG. 9A a full generally circular sail lines 809 cover survey area 818. After completing a complete circle, the streamers a towed in another circle displaced by some distance, DX. After the streamers are towed in a number of progressing circles along the x-axis, the streamers are then displaced some distance, DY, in the y-axis as shown in FIG. 9B. After the y-axis displacement the streamers can be pulled in a number of circles along the x-axis back toward the first circle. This alternating pattern for x-axis and y-axis displacement can continue until the sail line pattern shown in FIG. 9C is formed.

Still referring to FIGS. 8 and 9A-9C, when a first generally circular sail line 809 is completed vessel 803 can move along the tangent with a certain distance, DX, in the horizontal direction, and starts a new generally circular sail line 809 as shown in FIG. 9A. Several generally circular sail lines 809 may be traversed until the survey border is reached in the horizontal direction. A new series of generally circular sail lines 809 may then be acquired in a similar way, but the origin will be moved with DY in the vertical direction. This way of shooting continues until the survey area is completely covered.

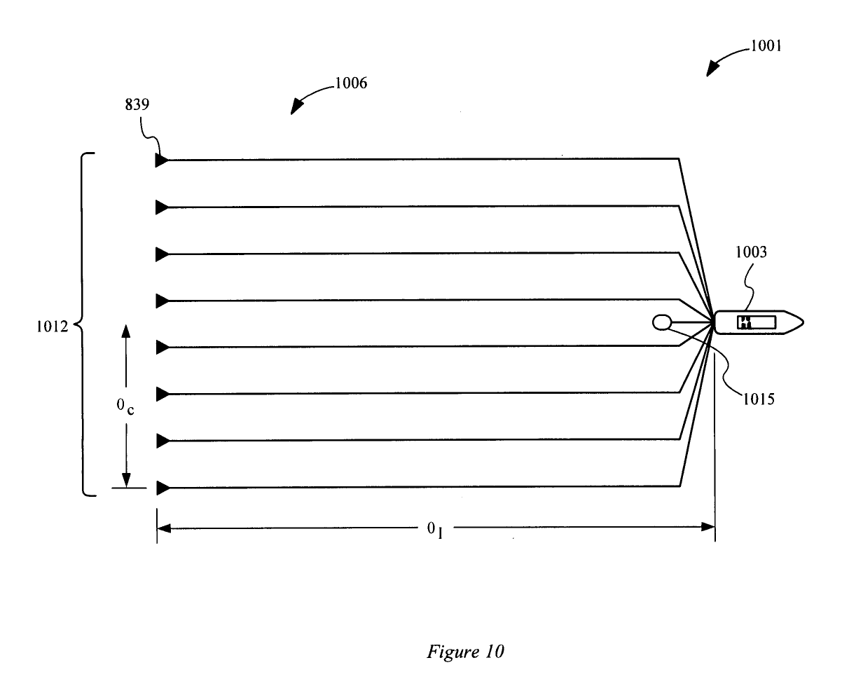

FIG. 10 is survey spread 1001 in a plan, overhead view according to some embodiments of the invention. Survey spread 1001, for example, can be survey spread 801 shown in FIG. 8. In some embodiments survey spread 1001 can include towed array 1006, towed by survey vessel 1003. Towed array 1006 can include any seismic array or streamer described throughout the disclosure. A computing apparatus can control seismic spread 1001 and can be located on-board the survey vessel 1003. Towed array 1006 can include any number of streamers. In the figure, eight streamers 1012 are shown. Seismic source 1015 is also included. Survey spread 1001 is shown after deployment but before embarking upon sail line 809, shown in FIG. 8. Consequently, streamers 1012 are shown in a straight arrangement rather than curved one of FIG. 8. Array 1006 can have a width, W_{c}, and a length, L₁.

Array 1006 also contains a number of positioning elements. For example array 1006 can include steering devices known as “deflectors”, “birds” and/or other steering devices. One suitable type of steerable bird is disclosed in U.S. Pat. No. 7,203,130, incorporated herein in its entirety of all purposes. Other types of positioning elements are known to the art and may be used in various embodiments. For example, a positioning element comprising a ducted body is disclosed in U.S. Pat. No. 7,377,224, incorporated herein in its entirety of all purposes. Some of these positioning elements are “steerable”, meaning that they can steer themselves and, hence, a part of the array 1006, to a desired position. In the illustrated embodiment, as will be discussed in further detail below, the birds can be steerable in both depth and crossline directions to help properly position other elements of the array 1006 and maintain the shape thereof.

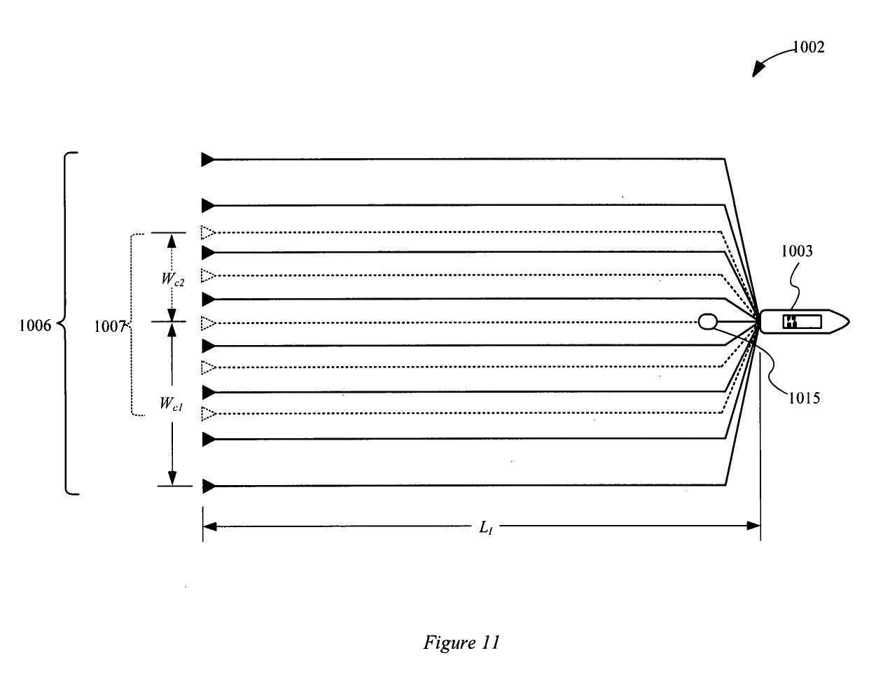

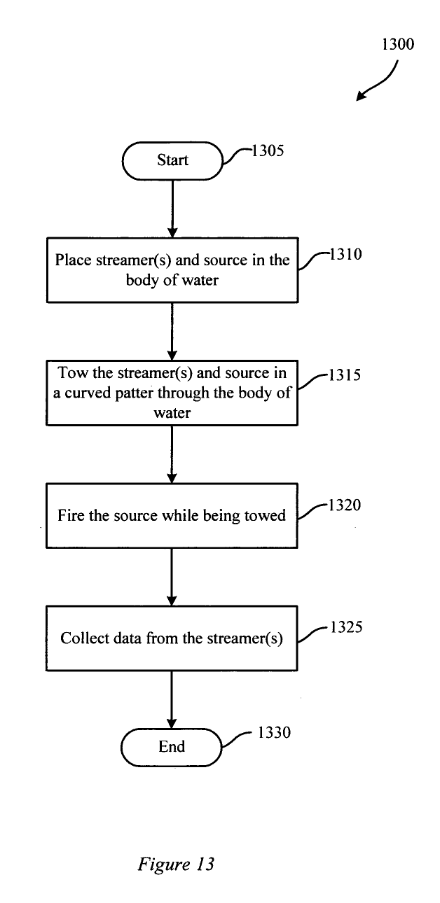

FIG. 11 is a survey spread 1002 in a plan, overhead view similar to survey spread 1001 shown in FIG. 10. In this embodiment survey spread 1002 includes two towed arrays. First towed array 1006 is shown with solid lines, and second towed array 1007 is shown with doted lines. Second towed array 1007 can be towed at a second depth that is deeper than the depth of the first towed array. In some embodiments, second towed array 1007 can cover a surface array that is smaller than first towed array 1006. For instance, the width, W_{c2}, of second array 807 is smaller than the width, W_{c1}, of the first array. FIG. 13 shows a side view of marine seismic data acquisition system 31 like the one shown in FIG. 2 along with second towed array 1007 towed at a second depth deeper than the first depth. Second towed array 1007 can include a set of seismic sensors 38.

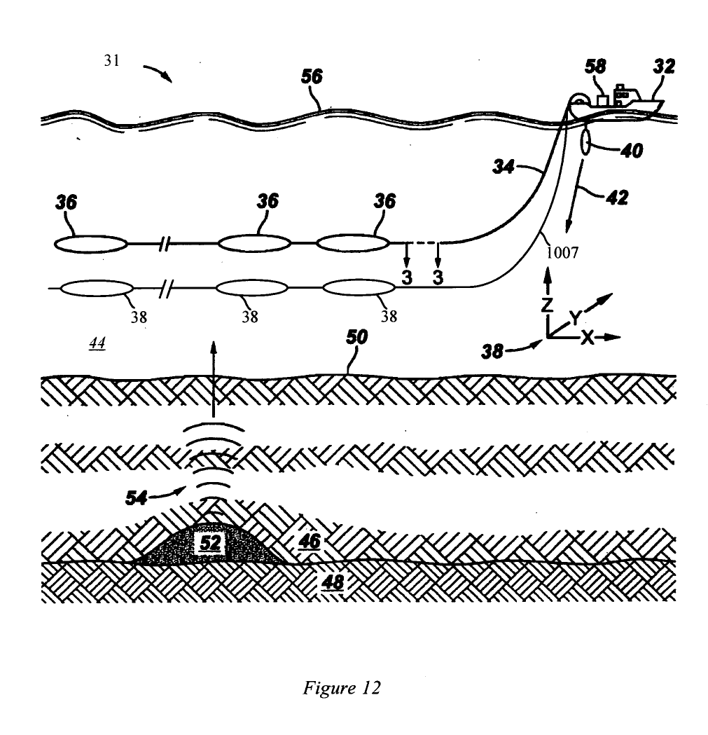

In some embodiments of the invention, the solid streamers are used in an over/under towing arrangement as shown in FIG. 12. In marine seismic acquisition, towing a streamer at a shallow depth makes the acquired data susceptible to environmental noise. In contrast, deep sources and/or deep streamers enhance the low frequencies, but attenuate the high frequencies. In addition, the data recorded via a deep tow have a higher signal-to-noise ratio (S/N) due to the more benign towing environment. A conventional towed-streamer survey design therefore, attempts to balance these conflicting aspects to arrive at a tow depth for the sources and cables that optimizes the bandwidth and signal-to-noise ratio of the data for a specific target depth or two-way travel time, often at the expense of other shallower or deeper objectives.

An over/under, towed-streamer configuration is a method of acquiring seismic data where cables are typically towed in pairs at two different cable depths, with one cable vertically above the other. The depths of these paired cables are typically significantly deeper than would be used for a conventional towed-streamer configuration. In conjunction with these paired cables, it is possible to acquire data with paired sources at two differing source depths.

In some embodiments, sparse-over/dense-under acquisition, the number of active receivers or receivers used at the deeper depth can be lower than the number of active receivers or receivers used at the shallower depth. In FIG. 11, for example, first streamer array 1006 (over streamers) includes 8 streamers and second streamer array (under streamers) includes 5 streamers. Any combination of over/under streamer numbers can be used. The density does not have to be a volume density and/or amount of streamers used at the different depths, it can equally be an area density, e.g. the number of active receivers with a given streamer or shot line spread. In the case of a dual streamer over/under configuration for a 2D survey the density can be interpreted as a line density of active receivers.

Sparse-over/dense-under acquisition may provide a method of generating a marine geophysical data set representing signals reflected from subterranean features, the signals having a survey bandwidth, wherein with the survey bandwidth there is one cross-over or transition frequency below which the data set is based on receiver signals obtained from a second depth and receiver signals obtained from a first depth are muted and above which the data set is based on receiver signals obtained from the first depth and receiver signals obtained from second depth are muted.

The seismic data recorded by the over/under towed-streamer configuration are combined in data processing into a single dataset that has the high-frequency characteristics of conventional data recorded at a shallow towing depth and the low frequency characteristics of conventional data recorded at a deeper towing depth. This combination process is commonly referred to in the geophysical literature as deghosting, as it effectively removes the so-called ghost notches from the receiver response.

FIG. 13 is a flowchart of process 1300 for performing marine seismic acquisition according to some embodiments of the invention. Process 1300 starts at block 1305. At block 1310 a solid seismic streamer(s) and a source is placed in a body of water. The solid streamer(s) and source are towed behind a vessel in a body of water and configured for receiving seismic signals generated by a seismic source in block 1315. As described above, the solid streamer(s) may be a seismic streamer(s) that is filled with a solid—a gel, thermoplastic elastomer, polymer and/or the like. The solid streamer(s) may also be towed in a curved pattern within the body of water. The curved pattern can include any full or partial circular or oval pattern. At block 1320 the source can be fired and data can be collected from the streamers at block 1325. Process 1300 can continue steps 1320 and 1325 for a period of time to collect multiple data sets. Process 1300 ends at block 1330.

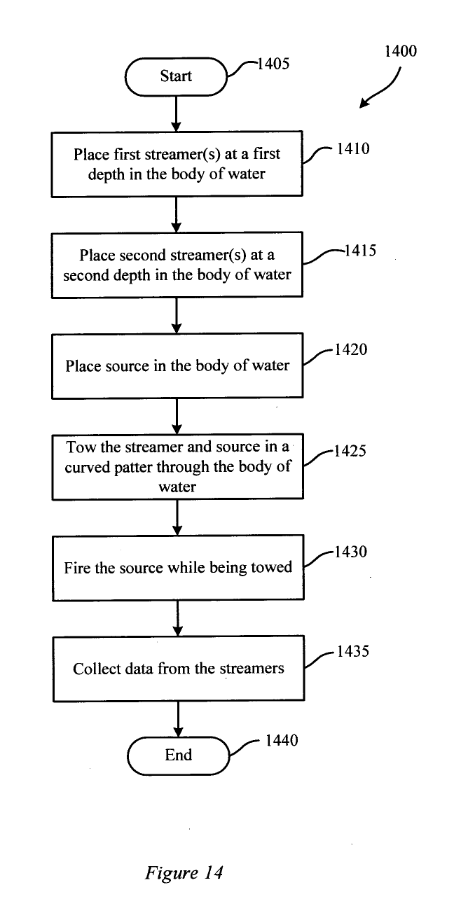

FIG. 14 is a flowchart of process 1400 for performing marine seismic acquisition according to some embodiments of the invention. Process 1400 starts at block 1405. At blocks 1410, 1415, and 1420 a first streamer(s), a second streamer(s) and a source are placed in a body of water. The first streamer(s) can be placed in the body of water at a first depth. And the second streamer(s) can be placed in the body of water at a second depth. The solid streamers and source are towed behind a vessel in a body of water and configured for receiving seismic signals generated by a seismic source in block 1425. As described above, the first and/or second solid streamer(s) may be a seismic streamer(s) that is filled with a solid—a gel, thermoplastic elastomer, polymer and/or the like. The first and second solid streamer(s) may also be towed in a curved pattern within the body of water. The curved pattern can include any full or partial circular or oval pattern. At block 1430 the source can be fired and data can be collected from the streamers at block 1435. Process 1400 can continue at steps 1430 and 1435 for a period of time to collect multiple data sets. Process 1400 ends at block 1440.

In some embodiments of the invention, the solid seismic streamers are used in a shooting (e.g. a coil shooting that includes a curved path) as described above. In a coil shooting the solid seismic streamers are towed in a somewhat circular or similar pattern through the body of water. As a result of the circular-type towing of the solid streamers through the body of water, a shear, stress and/or pressure may be developed across the solid material. In some embodiments of the invention, the application of shear, stress and/or pressure generated across the solid streamer from the circular-type pattern on the solid material, the solid material, for example, being viscoelastic and comprising a gel, thermoplastic elastomer, polymer, cross-linked polymer, thermally reversible gel, permanent gel and/or the like, can cause a change in the physical properties of the solid material. For example, the shear generated by the coil shooting may change the viscosity, attenuation coefficient and/or the like of the material.

In some embodiments of the invention, the change in the physical properties of the solid streamer material may be used so that the solid streamer material acts as a noise filter. In some embodiments of the invention, a coil shooting with a solid streamer is performed and the synergistic effect of the combination provides for an improved received seismic signal, an increase in signal to noise ratio and/or the like.

In some embodiments of the invention, modeling, experimentation, processing of data, prior use and/or the like may be used to determine the effect of the stress on the attenuation of seismic signals, acoustic signals and/or the like passing through one or more of the solid streamer materials. In one embodiment, a solid streamer material may be selected for the solid streamer based on the results of the modeling, experimentation, processing of data, prior use where the solid streamer material provides for a desired attenuation of the received signal. The physical effect of the stress on the solid streamer material may be non-linear so, in some embodiments of the invention, may affect noise differently from the seismic signal received by the solid streamer.

In some embodiments of the invention, the effect of stress on the solid streamer material and/or the value of the stress for a coil shooting pattern may be used to process seismic data from the signal received by transducers in the solid streamer after the signal has passed through the solid streamer material. Merely by way of example, the known effect of shear stress, resulting from the curved motion of the solid streamer through the body of water in the coiled shooting, on the transmission of a seismic signal through the solid streamer material may be applied in the processing of the seismic data obtained from the solid streamer. For example, transmission properties of the seismic signal through the solid streamer material may be modeled, experimentally measured and/or the like for the applicable shear stresses.

As described herein, solid streamers may provide for seismic data acquisition and may be tuned, by adjusting the properties of the solid material, to the conditions surrounding the solid streamer. Moreover, unlike prior streamers, which use an essentially Newtonian fluid, kerosene or the like, the solid streamers may react differently with regard to seismic data acquisition in accordance with conditions surrounding the streamer and/or the towing pattern/depth of the streamer. Applicants have determined that whereas the differing in response of the solid streamers to different conditions may be considered an impediment to using solid streamers in an over-under configuration, the differing response may in one embodiment of the invention be used in the processing of a combination of seismic data from the solid streamers at the different depths and in another embodiment of the invention the differing response may be accounted for and/or attenuated in the processing of a combination of seismic data from the solid streamers at the different depths.

Hence, according to a first aspect of the invention there is provided a method of performing a geophysical survey, comprising the moving of solid streamers through a body of water in at least two different depths and using said solid streamers to record within a survey frequency bandwidth geophysical signals as reflected from subterranean features. In one aspect, the solid streamers are used in a sparse-over/dense-under acquisition configuration. In some embodiments of the invention, the solid streamers may be used to collect data at a shallow depth at one temporal location and the solid streamers may be used to collect data at the deeper depth at a different temporal location. In certain aspects, the temporal location may be separated by seconds, minutes, hours, days, months or even years.

In a method according to some embodiments of the invention, a first depth may be chosen for towing the solid streamer such that the upper limit of the practical survey bandwidth is closer to a first ghost notch than to a second ghost notch in the spectral response at the first depth and a second depth may be chosen such that the frequency of a first maximum in a spectral response at the second depth is 90 percent or less of the frequency of a first maximum in a spectral response at the first depth and the wavefield is effectively sampled at a lower density at the second depth than at the first depth.

The spectral response or response as referred to herein is the depth dependent spectrum of an up-going plane wave with vertical incidence interfering with the down-going wavefield as reflected from the sea-surface or any equivalent thereof. This spectral response is based on the constructive and destructive interference of the up- and down-going wavefield at the depth in question. Incidence angles other than vertical can be considered without changing the basic shape of the response spectrum.

Because solid streamers may acquire seismic data differently at the different depths and effects such as temperature or the like may affect the interaction of the solid material with seismic signals and/or noise acquired at the solid streamer, knowledge of the difference in response of the solid streamers at the different depths may be used to process the seismic data acquired in an over-under seismic acquisition. For example, the difference in response of the solid seismic streamers at the different depths may be used to determine noise content in the acquired seismic data. In another aspect of the invention, knowledge of the difference in response of the solid streamers at the shallow and deep depths—which knowledge may be determined theoretically, by experimentation, by prior use of the solid streamers, by computer modeling and/or the like—may be used in the processing of the acquired seismic data such that the difference in response of the solid seismic streamers at the different depths is included/accounted for in the processing of the seismic data field determined from the seismic data acquired at the shallow and deep depths. In some embodiments, a conventional, non-solid streamer(s), may be towed at one depth and a solid streamer(s) towed at the other depth and a combined seismic data acquisition may be determined by combining the data collected by the different streamers.

In some embodiments of the invention, a sensor, such as for example a temperature sensor, may be coupled with the solid streamers at the different tow depths to determine a difference in conditions applicable to the solid streamers at the different depths. This difference in conditions as sensed by the sensor may then be used to process a combined seismic data signal from the outputs of the solid streamers at the different depths.

For example, in conventional over/under processing of streamer signals, an effective response curve for the streamers is determined as being essentially the average of the two response curves of the over and the under streamers over the bandwidth of the survey. As a result of this over/under combination the effects of the ghost notches are cancelled from the receiver response, thus amounting to a deghosting of the received geophysical signals.

In sparse-over/dense-under acquisition using solid streamers, the signals from the shallow solid streamer(s) may be effectively muted from the lower limit of the bandwidth up to a transition or cross-over frequency. In the frequency interval from the transition frequency to the upper limit of the survey bandwidth the response of the deep solid streamer is effectively muted and the response of the shallow solid streamer dominates the overall response of the survey. The combination of the shallow and deeper spectra can hence be carried out through simple surgical mute and replace after re-datuming to the same (arbitrary) depth.

While the principles of the disclosure have been described above in connection with specific apparatuses and methods, it is to be clearly understood that this description is made only by way of example and not as limitation on the scope of the invention.

What is claimed is:

1. A method for acquiring marine seismic data, comprising:
placing a source in a body of water;
placing a first streamer in the body of water, wherein the first streamer comprises a solid filler material and one or more sensors;
towing at least one of the first streamer and the source in a curved pattern through the body of water;
firing the source in the body of water; and
collecting data from the first streamer as the first streamer is towed through the body of water in the curved pattern.

2. The method according to claim 1, wherein the first streamer comprises a plurality of streamers.

3. The method according to claim 1, wherein the filler material comprises at least one of a gel, a thermoplastic elastomer, a permanent gel, a thermo-reversible gel, thermo-gel, a polymer, and a cross-linked polymer.

4. The method according to claim 1, wherein a filler of the solid streamer is configured to undergo a linear response to an applied shear force.

5. The method according to claim 1, wherein a filler of the solid streamer is configured to undergo a non-linear response to an applied shear force.

6. The method according to claim 1, further comprising:
processing the collected data, wherein the step of processing the collected data comprises processing an effect of the filler material on the collected data.

7. The method according to claim 6, wherein the effect of the filler material on the collected data is processed for properties of the filler material under an applied shear force.

8. The method according to claim 1, wherein the curved pattern comprises a substantially circular or oval pattern.

9. The method according to claim 1, wherein the filler material comprises a Kraton thermo-gel.

10. The method according to claim 1 further comprising:
placing a second streamer in the body of water;
towing the second streamer at a second depth through the body of water, wherein the first streamer is towed at a first depth different than the second depth; and
collecting data from the second streamer as the second streamer is towed through the body of water at the second depth.

11. A seismic streamer comprising:
a streamer body having a length and a channel;
a solid streamer core disposed within the channel of the streamer body;
a seismic sensor disposed within the channel of the streamer body;
a wire coupled with the seismic sensor and disposed within the streamer body channel having a length, wherein the wire length is longer than the length of the streamer housing; and
means for imparting slack in the wire within the streamer body channel.

12. The seismic streamer according to claim 11, wherein the means for imparting slack in the wire within the streamer body channel provides slack in the wire such that the length of the wire with slack is substantially the same as the length of the streamer body.

13. The seismic streamer according to claim 11, wherein the streamer body is filled with a filling, wherein the filling comprising a material selected from the group consisting of a gel, a thermoplastic elastomer, a permanent gel, a thermo-reversible gel, a thermo-gel, isoparaffin, a polymer, a cross-linked polymer, and Kraton G.

14. The seismic streamer according to claim 11, wherein the streamer body is filled with a gel that transforms into a solid form in contact with water.

15. The seismic streamer according to claim 11, wherein the means for imparting slack in the wire within the streamer housing channel comprises providing a corrugated or S-shape to the wire.

16. The seismic streamer according to claim 11, wherein the means for imparting slack in the wire within the streamer housing channel comprises a plurality of cavities within the streamer body.

17. The seismic streamer according to claim 16, wherein plurality of cavities within the streamer body are disposed at various portions within the streamer body such that the wire is substantially taut between each cavity.

18. The seismic streamer according to claim 11, wherein the wire comprises a wire bundle.

19. A method for acquiring marine seismic data, comprising:
placing a first streamer in a body of water at a first depth, wherein the first streamer comprises a solid streamer;
placing a second streamer in the body of water at a second depth that is deeper than the first depth, wherein the second streamer comprises a solid streamer;
placing a source in the body of water;
towing the first streamer, the second streamer, and the source through the body of water in a curved pattern;
firing the source while the source is being towed through the body of water; and
collecting first data from the first streamer and second data from the second streamer as they are towed through the body of water.

20. The method according to claim 19, wherein the first streamer is towed at a first temporal location and the second streamer is towed at a second temporal location that is different than the first temporal location.

21. The method according to claim 19 further comprising:
sensing a first condition at the first depth using the first streamer; and
sensing a second condition at the second depth using the second streamer.

22. The method according to claim 19 further comprising combining the first data and the second data.

23. The method according to claim 19 further comprising determining a difference data by calculating a difference between the first data and the second data.

24. The method according to claim 23 further comprising attenuating noise in the collected data using the difference data.

25. The method according to claim 23 further comprising attenuating noise in the first data streamer by subtracting the difference data from the first data.

26. The method according to claim 19, wherein the first streamer comprises a first plurality of streamers and the second streamer comprises a second plurality of streamers.

27. The method according to claim 26, wherein the first plurality of streamers are placed in the body of water defining a first area and the second plurality of streamers are placed in the body of water defining a second area, wherein the first area is larger than the second area.
